(19) United States
(12) Patent Application Publication
(10) Pub. No.: US 2009/0030909 A1
(43) Pub. Date: Jan. 29, 2009

(54) METHODS, PRODUCTS AND SYSTEMS FOR MANAGING INFORMATION

(76) Inventor: ROBERT BRAMUCCI, Ile Bizard (CA)

Correspondence Address: GILBERTH & ASSOCIATES, P.C., P.O. BOX 2428, BELLAIRE, TX, 77401-2428, US

(21) Appl. No.: 11/782,502

(22) Filed: Jul. 24, 2007

(51) Int. Cl. G06F 7/00

(52) U.S. Cl. 707/10

(57) ABSTRACT

Methods, products and systems for managing information comprise a computer-based information warehouse comprising information files provided to a user on-demand. Each information file is assigned a unique identification (ID) code. Entry of ID code into code input device results in automatic execution of corresponding information file from the information warehouse to a computer in communication with both input device and information warehouse. A function menu enables user-selection of one or more options relating to said information file. Methods, media and systems for monitoring activity relating to each file of the information warehouse.

### BACKGROUND

1. Technical Field

The present disclosure relates generally to methods, media and systems for managing and distributing information, and more particularly, to computer-based methods, media and systems for managing and distributing information.

2. Background Information

Information is present in our lives in an abundant supply. The information might relate to out personal lives such as information relating to friends and family, one's education history/record, one's medical history/record, employment history, financial records. The information might relate to our businesses such as advertising, marketing, research information, portfolios, and the like. Regardless of the type of information, virtually every aspect of our lives comprises a volume of it. Managing this information can be improved upon, and methods, apparatus, and systems for managing information are of use for the private sector and the public sector as well.

One example of information present in an over-abundant supply is advertising and marketing information. Consumers are bombarded by advertisements (“ads”) on a daily basis yet the majority of the ads have little to no relevance to the consumers who receive them. From the consumer's perspective, advertising is generally perceived as bothersome and intrusive and thus consumers often dislike and/or ignore the ads. From the advertiser/marketer's perspective, a large amount of resources (e.g., time and money) are placed on advertising in hopes of stimulating consumer interest in and desire for the advertised products. The advertiser/marketer's main goal being to increase sales and profit from the advertised products. Unfortunately, advertiser/marketers generally do not know who sees their advertisements, and/or whether the ads influence consumers and/or sales of the products therein.

With the increasingly widespread use of computer-based technology including but not limited to computers, the Internet, mobile phones, and handheld computer devices, advertising and marketing media has expanded to include not only hard-copy printed material for example but not limited to newspapers and magazines, and “traditional” electronic media for example, but not limited to, television and radio, but also electronic and computer-based media including but not limited to the World Wide Web (“Web”), mobile phones, interactive touchscreens, and interactive three dimensional displays/images. As a result, many marketers, advertisers, publishers, businesses and the like now have Web sites comprising goods and services, and/or online purchasing for their goods and services available to consumers.

The dissemination of information, goods and services via the Web and other computer-based and computer-related technology is not without drawbacks. For example, while browsing/surfing the Web, a user is again bombarded by information, numerous ads and pop-ups and, similar to the situation with television, radio and hard-copy print media, much of the information and ads are perceived as annoying and are irrelevant to his needs. With respect to information, advertised products, and/or services that are of interest to a user. these are often troublesome to track down and obtain on the Web. For example, assuming an individual has knowledge of a business's Web address, the individual generally must go through a number of steps in order to arrive at the Web site, followed by further steps to arrive at the desired information or product Generally an individual must manually enter the Web address in his Web browser and then, upon arriving at the desired Web site, generally he must navigate his way around/through the site in order to locate the information of interest. This is by no means a simple task as often times Web sites are cumbersome or difficult to navigate, and/or have an abundance of items and information, which may or may not be presented in a clear fashion. For the average individual with a busy lifestyle, and especially those individuals with minimal Web browsing skills, any one or more of these steps may be daunting enough endeavors to cause him to lose interest.

With respect to accessing Web sites and Web pages, changes have been made directed at simplifying the process. For example, U.S. Pat. No. 6,745,234, issued Jun. 1, 2004, to Philyaw and Mathews teaches a method for controlling a computer wherein one or more remote locations disposed on a network are accessed in response to scanning an optical code. A first computer disposed on the network connects to a scanner for scanning the optical code of a product by a user. The scanner is uniquely identified with a scanner distributor by a scanner identification number. A second computer disposed on the network is accessed in response to the user scanning the optical code with the scanner, wherein a lookup operation is performed at the second computer to match the scanner identification number with the scanner distributor to obtain remote routing information of the one or remote locations. The remote routing information is returned from the second computer to the first computer in order to access the one or more remote locations disposed on the network. The one or more remote locations are accessed to return remote information to the first computer for presentation.

U.S. Pat. No. 6,505,776 issued Jan. 14, 2003, to Wiley et al, teaches a body-wearable bar code symbol driven system for accessing information resources from information servers connected to communication networks, including the Internet. The body-wearable system includes a hand-mounted bar code symbol reader for reading bar code symbols encoded with information representative of information resources stored in information servers connected to the Internet and supporting the TCP/IP standard. A computer platform, worn on the body of the operator, is provided for supporting an Internet browser. A telecommunication modem is operably connected to the computing platform in order to establish a two-way telecommunication link between the Internet browser and an Internet service provider (ISP) connected to the Internet. In response to reading bar code symbols, the Internet browser automatically accesses information resources from Internet information servers using the information encoded in bar code symbols read by the bar code symbol reader. A display panel is provided for visually displaying information resources accessed from the Internet information servers by the bar code symbol driven Internet browser.

U.S. Patent Application Publication No. US 2006/0124742 A1, published Jun. 15, 2006, to Rines et al., discloses methods and apparatus for accessing Web sites. The methods of Rines allow a reader of a publication that is associated with a particular publisher Website to access supplemental material contained on the publisher's Web site relevant to a particular passage in the publication by scanning a barcode for the passage. By using a scanner to scan the barcode at a relevant passage in the publication, a Web browser in communication with the scanner is directed to the particular Web page corresponding to the particular barcode.

Despite advance in the field, there remains a need for methods, media and systems for information management.

Thus, there is a need in the art for methods, media and systems that provide a user with on-demand information.

There is another need in the art for methods, media and systems that monitor activity relating to computer files.

There is even another need in the art for methods, media and systems that enable a user to obtain information via the Internet without the need to view, navigate and/or search a Website or Webpage.

There is still another need in the art for methods media and systems that provide on-demand advertising and marketing to a consumer.

There is yet another need in the art for methods, media and systems that allow an advertiser/marketer to monitor and track activity relating to any one or more advertisement and/or product.

There is even still another need in the art for methods, media and systems that enable a business, for example a publisher, to complement it's hard copy/print media products with Web-based/soft copy media.

These and other needs in the art will become apparent to those of skill in the art upon review of this specification, including its drawings and claims.

### SUMMARY

The following presents a general summary of some of the many possible embodiments of this disclosure in order to provide a basic understanding of this disclosure. This summary is not an extensive overview of all embodiments of the disclosure. This summary is not intended to identify key or critical elements of the disclosure or to delineate or otherwise limit the scope of the claims. The following summary merely presents some concepts of the disclosure in a general form as a prelude to the more detailed description that follows.

According to one non-limiting embodiment there is provided a computer-implemented method for managing information comprising the steps of: a) entering identification code data in a first computer, wherein the identification code data is unique to a computer file maintained in a file system on a second computer, wherein the file system comprises a multitude of files each having a unique identification code assigned thereto; b) communicating the code data via the Internet to a second computer; c) retrieving the computer file unique to the code data; d) executing the computer file on the second computer; and e) displaying step d) via the Internet on a display device in communication with the first computer. Generally steps b), c), d) and e) take place automatically as a result of step a). The method may further comprise the step of: f) executing on the second computer a menu file comprising a list of user options which are displayed via the Internet on the display device. Generally step f) take place automatically after step e). The method may further comprise the step of: g) maintaining in one or more event tracking databases event data relating to any one or more of steps a), b), c), d), e), and f). Generally the one or more databases are maintained on the second computer, and step g) takes place automatically after each of steps a), b), c), d), e), and f). The method may further comprise the step of h) requesting event data from said one or more event tracking databases.

According to another non-limiting embodiment there is provided an information handling system comprising: a processor; memory accessible by the processor and having stored therein a plurality of files, wherein each of the plurality of files is uniquely associated with identification code data that when received from a user's computer causes the system to execute the file associated with the code data and display file information as instructed by the file.

According to even another embodiment there is provided a system for managing information comprising: a processor; memory accessible by the processor and having stored therein a plurality of files, wherein each of the plurality of files is uniquely associated with identification code data; and a print media product comprising one or more printed portions, each portion comprising a unique identification code, uniquely associated with one of the plurality of files, each code comprising identification code data, and wherein the identification code when received from a user's computer causes the system to execute the file associated with the code and display file information as instructed by the file.

According to still another embodiment there is provided an information handling system readable medium having stored thereon a set of instructions that when executed on an information handling system, instruct the information handling system to: receive identification code data from a first computer, wherein the identification code data is unique to a computer file maintained in a file system on the information handling system, wherein the file system comprises a multitude of files each having a unique identification code assigned thereto, and wherein in response to receiving the identification code data the information handling system is further instructed to execute the file unique to the code data and display file information as instructed by the file. The set of instructions may further instruct the information handling system to execute a menu file and display information as instructed by the menu file. The set of instructions may further instruct the information handling system to maintain in one or more event tracking databases event data relating to one or more of the receiving code data, executing the file, displaying file information , and executing the menu file.

According to yet another embodiment there is provided a print media product comprising one or more printed portions, each portion comprising a unique identification code, each code comprising identification code data uniquely associated with a computer file maintained in a file system maintained on a first computer, and wherein the identification code data when entered into a second computer is communicated to the first computer causing the uniquely associated computer file to be executed on the first computer and to display file information as instructed by the file. Generally the identification code is selected from the group consisting of barcodes, alphabetic codes, numeric codes, alphanumeric codes, binary codes and all combinations thereof. Generally the print media product is selected from the group consisting of magazines, newspapers, advertising flyers, directories, brochures, pamphlets, posters, tickets, collectible and playing cards, all types of cards, business cards, paper, books, and all combinations thereof. In one non-limiting embodiment the print media product is a magazine.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIG. 1 is a flow chart of a non-limiting method of the disclosure.

FIG. 2 is a flow chart of a non-limiting method of the disclosure.

FIG. 3 is a schematic representation of a non-limiting system of the disclosure.

### DETAILED DESCRIPTION

The present disclosure is directed to computer based methods, media and systems for managing information. The methods, media and systems of the present disclosure provide a user with a shortcut through the Internet by enabling a user to obtain information via the Internet without having to view and/or browse a Web site, or view and/or browse a Web page. The present methods, media, and systems provide a user with on-demand access to information. Generally the information is stored in the form of a computer file and may be any type of computer file known in the art. The files are maintained in folders or directories which are part of a file system, referred to herein as the “information warehouse.” Each information file in the information warehouse of the present disclosure is assigned a unique identification code (ID code) which may be used to access and/or retrieve the information file and data relating thereto. Each ID code of the present disclosure is configured to automatically execute a set of instructions loaded/installed on a computer when the ID code is received by the computer. The set of instructions automatically directs the computer to the information warehouse which is maintained on a second computer, and accesses the information file therein corresponding to the ID code of interest. The file may then be executed and is displayed on a display device associated with the first computer. In another embodiment, the file may be downloaded to the first computer and then executed on the first computer. The present disclosure further provides methods, media and systems allowing one or more authorized individuals/parties to access and/or obtain data relating to activity with respect to information files of the disclosure. The methods , media and systems of the present disclosure are computer-based and any applicable computer technology, hardware, and programming methodologies known in the art may be utilized herein.

The present disclosure further provides methods, media and systems that enable a business, for example a publisher, to complement it's hard copy/print media products with Web-based/soft copy media. Thus, a business such as, but not limited to, a publisher is able to utilize the Internet as a part of his business instead of perceiving the Internet as a competitor or a threat to his business (i.e., hard copy/print media products).

With respect to the information files of the information warehouse of the present disclosure, the files may be any type of computer file known in the art. The files may be text, audio, graphic, animation, video files, or any combinations thereof. The information files of the present disclosure may comprise information relating to anything one might wish to cataloge, organize and/or make available for access to another one or more individuals or group. Thus, the information files may comprise information relating to any one or more products available from a manufacturer, advertiser, supplier and/or business. As used herein, the manufacturer, advertiser, supplier and/or business may comprise one individual or more than one individual. The product may be any type of goods, service, and combinations thereof that may be available for purchase by a consumer. The information files may comprise information relating to the product such as but not limited to price, description of product function, product specifications, product composition, product content, history of said product, manufacturer information, photographic and/or diagramatic representations and/or views of the product, demonstration of the product in use, testimonials of said product, and all combinations thereof.

The information files may comprise information relating to one or more individuals, or one or more groups wherein the information may be of interest to any one or more individual or group. This includes but is not limited to health information, medical information, any type of personal information, contact information, emergency information, curriculum vitaes (CVs) and/or resumes, academic/educational transcripts and information, bios, demos, portfolios, event information, and all combinations thereof.

As stated, the information may be directed to anything one might wish to cataloge, organize and/or make available for access to another one or more individuals or group. The information may be directed to any field such as but not limited to fashion, beauty, health, education, learning, history, science, engineering, architecture, art, music, medicine, fitness, nutrition, automotive, entertainment, sports, lotteries, business, finance, news, polls, politics, environment, and all combinations thereof. The information files may comprise any form of media representing any one or more personality from any walk of life such as but not limited to, political figures, movie stars, artists, musicians, rock stars, sport figures, fashion models, the “man on the street”, the average person and may be directed to any group or individual including but not limited to governments and agencies thereof, non-profit organizations, individuals and industry.

Generally each information file in the information warehouse of the present disclosure is assigned a unique identification (ID) code which may be used to access, manage, and/or retrieve the file and/or information relating to the file. Generally, no two or more information files will share the same ID code at a given time. With respect to ID codes suitable for use in the methods and systems of the present disclosure, any types of indicia, codes, notation and the like known in the art and suitable for use in inventory and identification purposes may be used herein. For example, the ID code may be any type of barcode, an alphabetical code, a numeric code, an alpha-numeric code, a binary code, a graphic icon, a symbol, and any multiples, mixtures and combinations thereof. The ID codes may be generated by any one or more method known in the art for generating unique values in a system, and all are suitable for use herein.

Within the information warehouse, the files may be organized in folders and/or directories and may be organized in any manner. The owner and/or creator and/or administrator of the information warehouse may determine the manner in which the files are organized. For example, files might be organized by topic, by source, by size, choronologically according to date created or date entered into the warehouse, by code, or any combinations thereof. Methods for creating and operating file systems, folders and directories are well known to those of skill in the art and any suitable for user herein. Generally when information is submitted for addition to the information warehouse, an information file comprising the information is created, and the file is assigned a unique ID code of the disclosure. Generally the assignments for the ID codes of the disclosure are maintained in a database useful for authenticating code input data as well as maintaining inventory of the information warehouse.

The ID codes of the present disclosure may be present in any one or more type of hard copy media and/or printed media such as but not limited to magazines, newspapers, advertising flyers, directories, brochures, pamphlets, posters, tickets, collectible and playing cards, all types of cards, business cards, paper and books. The ID codes may be present on any one or more types of label, tag or similar item that may be affixed or attached to a product, object, person, and/or animal. The ID codes may be present on any one or more types of pendant, bracelet, necklace, ring, pin, brooch, or any other jewelry and/or ornamental type of item which may be attached to and/or worn by any person, animal, object and/or article. The codes may be applied by any method known in the art including but not limited to all forms of printing, IC chips, painting, writing, stamping, engraving, embossing, and combinations thereof. The ID codes may be tattooed on any one or more people and/or animals. The ID codes may be displayed on a screen such as but not limited to a computer screen, a televison screen, a display panel of a mobile phone, a display panel of a wireless handheld device. The ID codes may be present and/or displayed in any one or more of the aforementioned methods and may be displayed directly, or may be embedded/encrypted within an advertisement, or a combination thereof.

According to one non-limiting embodiment, the ID code is present on one or more types of hard copy print media as part of an advertisement for a corresponding product referenced therein. As previously stated, hard copy print media includes but is not limited to magazines, newspapers, advertising flyers, directories, brochures, pamphlets, posters, tickets, collectible and playing cards, all types of cards, business cards, paper and books. The advertisement may be any type of advertisement and may comprise one or more lines of text, one or more images, and all combinations thereof. The publication may comprise a single advertisement or may contain more than one advertisement. Regardless of the number of advertisements and/or the number of products per advertisement, each unique product corresponds to a unique ID code of the disclosure. A reader having access to the print media may enter an ID code of interest into a code input device of the disclosure in communication with a computer to which the user has access. The code information is communicated to software of the disclosure which may result in the corresponding information file being downloaded and executed on the user's computer from the information warehouse on a second computer. In another embodiment, the file is executed from the second computer and displayed on a display device associated with said first computer. The user is thus able to view the information of the information file and may make selections pertaining thereto from the selection menu. Media, software and systems of the disclosure are described in further detail elsewhere in the present disclosure.

According to another non-limiting embodiment, the ID code is present on one or more type of hard copy print media and is associated with an information file that corresponds to an individual group. As stated previously, hard copy print media includes but is not limited to magazines, newspapers, advertising flyers, directories, brochures, pamphlets, posters, tickets, collectible and playing cards, all types of cards, business cards, paper, and books. The information file may comprise one or more lines of text, one or more images, one or more pages, and all combinations thereof. The hard copy media may comprise a single ID code of the disclosure of may comprise more than one ID code wherein each code is unique to an information record. In one preferred embodiment, the ID code is present on a type of card or any type of paper and the corresponding information file comprises at least a portion of an individual's medical record, or an individual's education record, or an individual's employment record, or any combinations thereof.

According to even another non-limiting embodiment, the ID code is present on one or more type of label, tag, jewelry, ornamental-type item, and combinations thereof, and/or the ID coded may be tattoed on a person or animal. The label, tag, jewelry, ornamental-type item may be attached to or worn by a person, animal, product, object and/or article. The corresponding information file may comprise contact information for the parent, guardian and/or owner of the person, animal, product, object and/or article, contact information for the person/animal's doctor/veterinarian and/or hospital, any relevant health information pertaining to the person/animal for example any medications the person/animal might be taking (e.g., insulin, anti-seizure medication, etc), and/or any medical conditions the person/animal might have (e.g., diabetes, epilepsy, a neurological disorder, altzheimer's, etc.), and all combinations thereof.

According to still another non-limiting embodiment, information relating to a person, animal, product, object, article and/or event is displayed on a display screen for example but not limited to an advertisement or announcement displayed on a television. Each advertisement or announcement may comprise unique embedded, encrypted and/or encoded data which corresponds to a unique ID code of the disclosure. The display device may be controlled manually, by remote control, or both. The control panel of the display device, the remote control for the display device, or both, comprise a dedicated button or key configured to be in communication not only with the display device but also with the information warehouse (via the Internet), or software of the disclosure loaded/installed on a computer accessible by a viewer of the display device, or both. The display device may also be configured to be in communication with the Internet. A viewer viewing the display device may press the button or key during display of an advertisement or announcement of interest. When a viewer presses the dedicated button or key during an advertisement or announcement of interest, the encoded data within the advertisement or announcement may result in the corresponding ID code being sent to the viewer's computer, and/or the corresponding information file of the information warehouse of the disclosure being executed and displayed on, and/or downloaded to the viewer/user's computer. For example, upon pressing the button or key during an advertisement or announcement of interest, a user may receive on his computer a confirmation message such as but not limited to an email or text message, containing the ID code for the corresponding information file. The user may then, at his convenience, enter the ID code into a system of the disclosure in order to view the corresponding information file. As another example, upon pressing the button or key during an advertisement or announcement of interest, the corresponding information file may be automatically executed from the information warehouse and displayed on the user's computer, or may be automatically downloaded from the information warehouse to the user's computer.

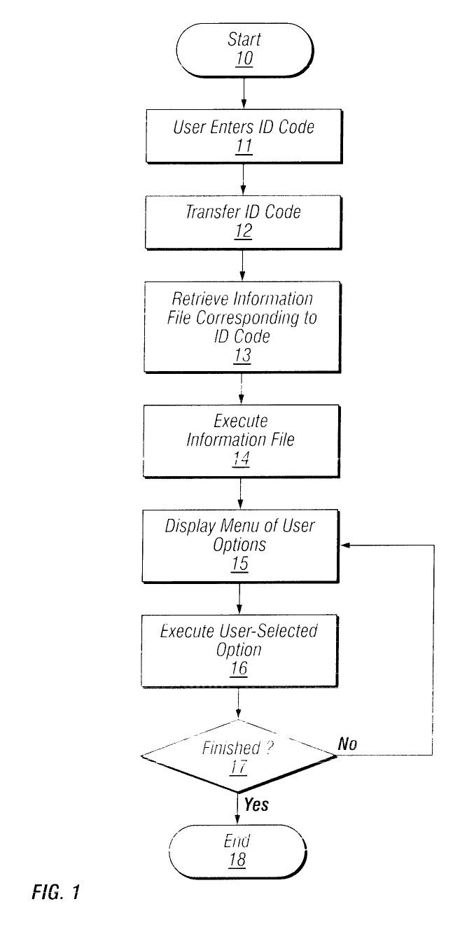

With the single step of entering an ID code of the disclosure into a system of the disclosure, a user is able to obtain on-demand information of interest via the Internet. Referring now to FIG. 1 there is provided a flow chart of a non-limiting method of the disclosure for providing on-demand information to a user. The method may begin in step 10. In step 11, an identification code (“ID” code) of interest may be entered by a user into a code input device of the disclosure. Code input devices include but are not limited to scanning devices, radio frequency detection devices, camera recognition devices, visual recognition devices, voice recognition devices, keyboards, keypads, touchscreens (including but not limited to surface computers and related technology), and any combinations thereof. The ID code may be entered manually for example but not limited to the user typing the ID code on a keyboard or keypad, for example but not limited to a computer keyboard, the keypad of handheld wireless device such as but not limited to a mobile phone, PDA, or similar device, or the ID code may be entered automatically by scanning the ID code for example but not limited to the user scanning the code with a scanning device, or placing the code in proximity to a touchscreen and/or surface computer having data entry capabilities, thereby enabling the screen/surface to receive the code data. In one non-limiting embodiment, the code comprises alphabetic, and/or numeric, and/or punctuation characters and is entered manually by being typed on a keyboard or keypad and does not require that the user have a scanner. In step 12, the code input device may communication the ID code information/data to software of the disclosure loaded/installed on the user's computer. Generally, when an ID code of the disclosure is entered into a code input device of the disclosure, the ID code may be converted from optical information to digital information. This digital information is then further processed by software of the disclosure. Upon receiving the code information, the client-side software may validate the code information in order to determine if the information is recognized. If the code information is recognized, then the software may communicate the code information to the information warehouse of the disclosure on a second computer in order to retrieve the information file therein which corresponds to or is assigned to the ID code. If the code is not recognized, a message may be provided to the user for example but not limited to displaying a message on the user's display device in communication with his computer, or by playing a distinct and aubible sound, or a combination thereof. As an alternative embodiment, or in addition, the code validation step may occur further downstream in processing an may be carried out by a server-side application installed on a second computer. In step 13, the client side application may communicate the code information to a server-side application associated with the information warehouse of the disclosure installed on a second computer in order to retrieve the information file therein which corresponds to or is assigned to the ID code. As previously indicated, the information file may be any type of computer file known in the art for storing, processing, displaying and/or handling information including but not limited to a text file, an audio file, a graphic file, an animation file, video files, multimedia files, and all combinations thereof. In one non-limiting embodiment, the file comprises text and graphics. In another non-limiting embodiment, the file is a multimedia file. In step 14, the information file corresponding to the ID code of interest may be executed from the second computer and displayed on the user's display device in communication with the user's computer. The file may be automatically executed, or the file may be executed upon user-selection of a play option such as but not limited to “play”, “execute”, or “start”. In one preferred embodiment, the information file is automatically executed on the display device. In another embodiment, in step 14, the file corresponding to the ID code of interest may be downloaded from the second computer onto the user's computer and either automatically executed on the user's computer, or executed upon user-selection of a play option such as but not limited to “play”, “execute”, or “start”. In step 15, a function menu may be displayed on the display device. The function menu may be a file separate from the information file, or it may be incorporated within and thus a part of the information file. Generally, the function menu is a file separate from the information file. The function menu may include any one or more options known in the art such as but not limited to the following options: save files; add to wishlist; add to favorites; add to shopping cart; buy/purchase now; tell a friend; find a dealer; request additional information; contact source; go to a linked Website or Webpage (any one or more Websites and/or Webpages relevant to the information file of interest may each be configured to be link/option within the menu including but not limited to the Website associated with the methods, media and systems of the present disclosure, and a Website associated with the content and/or topic of the information file); add user information to mailing list; fill out a survey, and leave a comment. The function menu and options may comprise any user interface technology known by one of skill in the art. Those skilled in the art will appreciate that user interface technologies and methodologies are well known, and thus are not repeated herein. In step 16, the user may select an option and the user-selected option may be carried out. With respect to the options of the function menu, each option may be configured to link to a relevant set of operational instructions for executing the selected option. As state, the function menu and options therein may comprise any user interface technology known in the art. In step 17, it may be determined whether or not the user is finished selection options. If no, the user is not finished, the method may return to step 16 for selection of one or more additional menu options. A user may return to the function menu any number of times to select any one or more additional options therefrom. If yes, the user is finished making selections, then the method may end in step 18. When the method ends, the option menu may be configured to close automatically, or to close upon user request, or a combination thereof. For example, the option menu may be configured to close after a designated period of time if the user does not close the menu. In one embodiment, the function menu file is executed from the second computer associated with the information warehouse via a web browswer on the user's computer.

According to yet another non-limiting embodiment of the disclosure there is provided software enabling a user to obtain on-demand information. This software may also be referred to herein as “client-side software”. Generally the software comprises a set of instructions that when executed on a computer enable said computer to process ID code data/information of the disclosure. In a preferred embodiment, on a computer on which the software has been loaded/installed, the processing instructions are automatically executed when ID code data/information is entered in the software/application. Processing may comprise receiving ID code data/information from a ID code input device. Processing may comprise transferring the ID code information and any data relating thereto to an application installed on a second computer associated with the information warehouse of the disclosure. Transferring the code information from a first computer to a second computer may be in the form of a request by the first computer for the ID code and/or the information file corresponding to the ID code of interest. Transferring the code information to a second computer may comprise use of proxies, gateways, tunnels, and any other intermediary network protocol/component known in the art. The second computer may decode the ID code data/information in order to identify and retrieve the corresponding information file. Processing may comprise executing the corresponding information file from the information warehouse and displaying it on the user's computer. In another embodiment, processing may comprise first downloading the corresponding file onto the user's computer. In one non-limiting embodiment, upon receipt of ID code information, the software of the disclosure is configured to automatically executed the corresponding information file from the information warehouse and display it on the user's computer. In FIG. 1, step 11 (user enters an ID code) is the only step of the method that a user must perform in order to receive the information of interest.

The client-side software of the disclosure may comprise a set of instructions that when executed on a computer enable validation/authentication of an ID code received on said computer in order to determine whether the code is a valid code of the information warehouse although generally an ID code validation step is carried out by a server-side application. The instructions may comprise one or more communications protocols that when executed on a computer enable the computer to communicate with code input devices of the disclosure, the server-side application associated with the information warehouse of the disclosure, the Internet, or a second computer on which the server-side application is installed and/or the information warehouse is maintained, or any combinations thereof. As an alternative or in addition, the ID code authentication step may occur further downstream in processing and may be carried out by server-side software of the disclosure and/or by any intermediary network protocol and/or component.

With respect to both client-side and server-side software of the present disclosure, the software may be written in any one or more suitable programming languages known in the art. The software of the present disclosure and also the information warehouse of the present disclosure are compatible for use with any software platform and/or operating system. The client-side software of the disclosure may be downloaded from a Webpage associated with the present disclosure and may be obtained by any individual having access thereto. Generally, obtaining the client-side software of the disclosure does not require special authorization. The client-side and/or server-side software of the disclosure may be encoded on any of a variety of media including, but not limited to, computer-readable media, machine-readable media, program storage media or computer program product. Such media may be handled, read, sensed and/or interpreted by any information handling system (IHS).

For ease of operation, the client-side and/or server-side software of the disclosure may undergo initialization upon start/boot up of a computer on which the software has been installed. Once initialized, the client-side software may be configured to display an ID code input window or box on the computer's display device for receiving ID codes and into which a user may enter/type ID codes of the disclosure. The ID code input window or box may be automatically displayed upon initialization of the software. Generally the ID code input window or box is visible and convenient to a user of the computer, but is not obtrusive to the user and operation of the computer. For example the ID code input window or box may be located on a taskbar or on the desktop.

According to even still other embodiments of the present disclosure there are provided methods, media and systems allowing one or more authorized individuals/parties to receive and/or access information relating to any one or more information file in the information warehouse. For monitoring and/or tracking purposes, any one or more event relating to the information files of the disclosure may be added to one or more designated databases. Thus, events occuring with respect to each information file of the disclosure may be monitored and the data maintained in one or more designated databases. As defined herein “events” include but are not limited to ID code entering/scanning events and related data, file download events and related data, file execution events and related data, and one or more option selection events (i.e., user selections from a function menu) and related data, any information regarding entry and/or removal of an information file into or out of the file system such as dates and/or times thereof, information regarding access to the information file in the file system and data relating thereto such as the party accessing the file, dates and/or times thereof, any type of bookkeeping information, and all combinations thereof. For example, each time an information file is downloaded onto a computer, the occurrence of the download event and any related information such as date and/or time of the event may be added to one or more designated databases. Each time an ID code is entered and/or scanned, the event and any related information such as date and/or time of the event, and/or source of the ID code may be monitored and the data added to one or more databases. Each time an information file is executed and/or displayed on a display device, the event and any related information such as date and/or time of the event may be monitored and the data added to one or more databases. Each time a user selects an option from a function menu, the selection event and any related information such as date and/or time of the may be added to one or more designated databases. The event information may be maintained in one or more designated databases. The one or more databases may be specific to a single type of event and comprise information regarding a single information file or more than one information file, or they may comprise data regarding more than one type of event and may be directed to a single or more than one information file, or any combinations thereof. Methods for managing data, compiling and maintaining lists, and compiling and maintaining databases are known by one of skill in the art, and any such methods are suitable for use herein. Generally the one or more databases are maintained on the same computer on which the information warehouse of the disclosure is maintained.

All or part of the data in the one or more databases may be obtained by an authorized party either by direct access to the data, by indirect access to the data via submitting a request/query, or any combinations thereof. Alternatively, or in addition, all or part of the data in the one or more databases may be configured to be automatically sent to an authorized recipient/part according to a schedule, for example but not limited to each time the database is updated, or after a certain time interval has lapsed, or after a database is updated a certain number of times, or all combinations thereof.

As defined herein, an authorized party may be any one or more individuals granted either direct or indirect access to information in one or more of the databases and is generally an individual or party associated with the subject of an information file of the disclosure such as but not limited to the owner of the information warehouse, a party designated by the owner of the information warehouse, an advertiser and/or producer and/or a marketer of a product of an information file of interest, and/or a party designated thereby, an individual or group referenced in the information file or a party designated thereby, and all combinations thereof. Generally the owner and/or administrator of the information warehouse, or a party designated thereby, is responsible for granting, suspending, terminating, denying, and al combinations thereof, authorization to access file information. By accessing and/or receiving event information of the database(s), an authorized party may track events such as but not limited to how many times and ID code has been scanned and/or entered, or how many times an information file relating to a product he supplies has been executed and/or downloaded, or purchasing information on one or more products he supplies and/or sells, or obtain user feedback information, or any combinations thereof. An authorized party is also able to track event activity with respect to period s of time, one or more or a range of dates, and combinations thereof. The tracking/event data may comprise the specific site/source of the information file of interest. For example, ID code printed in a publication, part of the code may comprise unique source data corresponding to the publication and unique publication information such as but not limited to the publication's title, publication issue and/or date, page on which the ID code appears, and all combinations thereof. Thus, an authorized party may track event activity with respect to any one or more sources of interest comprising any one or more ID codes of the disclosure. For example, an authorized party may query for event activity relating to any one or more specific media source such as but not limited to a particular magazine or a particular newspaper. This capability allows an advertiser/marketer to determine the effectiveness of a particular ad and/or particular publication. Generally the ID codes of the disclosure are configured to comprise all the relevant source tracking data pertaining thereto, such that scanning/entering an ID code of interest into a system of the disclosure results in all corresponding source data automatically being saved in one or more designated databases. With the ability to track event activity relating to any one or more information file of interest and/or any one or more media source of interest, an authorized party such as but not limited to an advertiser/marketer is able to analyze and/or modify and fine-tune his advertising/marketing strategies.

The tracking software of the disclosure comprises a set of instructions that when executed on a computer enable the computer to track any type of activity and bookkeeping data relating to the ID codes, information files, the information warehouse, and databases of the disclosure. Generally, the tracking software comprises server-side applications and is thus also referred to herein as “server-side software”. The tracking software of the disclosure is generally loaded/installed on the computer on which the information warehouse is maintained. The tracking software is generally for use only by authorized parties such as the creator/author and/or administrator of the information warehouse. In one embodiment, all activity relating to the ID code sand the information files is monitored and the data added to the databases of the disclosure. The tracking software may comprise a set of instructions that link an option menu file to each information file when the information file is executed and displayed a user's computer. Generally an option menu is displayed to a user following execution of each information file.

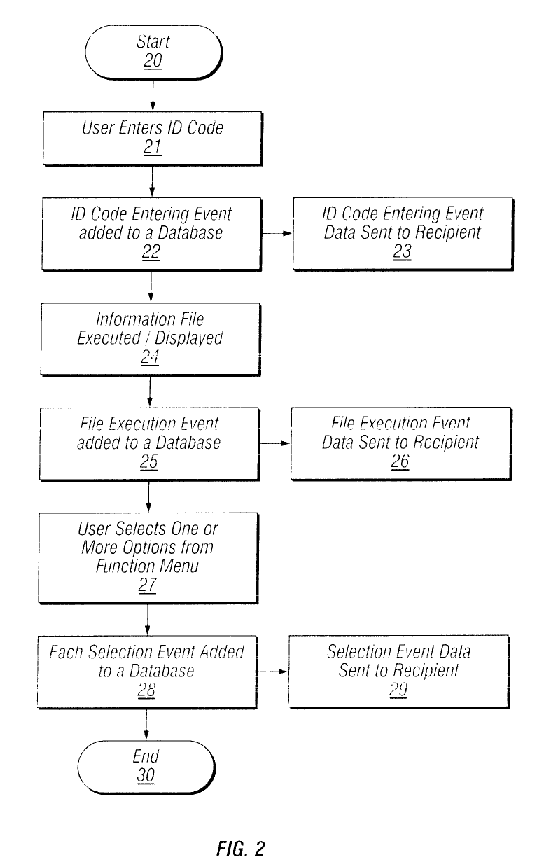

Referring now to FIG. 2 there is provided a flow chart of a non-limiting method of the disclosure for monitoring event data relating to information files in an information warehouse. The method may start in step 20. In step 21, an ID code may be scanned or entered by a user as described previously. In step 22, the event and related information such as date and/or time of the event may be added to a designated database. Related information may comprise the source/reference data for the ID code being scanned/entered such as a publication reference, a television or radio commerical reference. For example if the ID code of interest is entered from a printed publication, related information may comprise data such as the title, issue, and/or page number of the publication. For those ID codes in publications and/or on commercials, the ID codes are created so they comprise source data unique to the publication or commerical thereby enabling tracking of these sources. In step 23, the event and related information such as date and/or time of the event may be automatically delivered to a recipient. In step 24, the information file corresponding to the scanned/entered ID code is executed and displayed onto a computer. In step 25 the file execution event and related information such as date and/or time of the event may be added to a database and in step 26 the file execution event may be delivered to an authorized recipeint. In step 27, a user may select an option on the function menu. In step 28 the selection event and related information such as date and/or time of the event may be added to a database and in step 29 the selection event data may be delivered to an authorized recipient. Steps 23, 26 and 29 may be configured using any of a number of parameters for example, the data contained therein may be sent to a recipient as a bath of data instead of individual data. The data may be sent to a recipient only after a desginated time period has lapsed. Configuring parameters for data transfer are known to those of skill in the art and all are suitable for use herein. Generally the one or more databases are maintained on the same computer on which the information warehouse of the disclosure is maintained. In one non-limiting embodiment, the recipient is an advertiser and/or marketer and the event information relates to how many times an ID code and/or information file corresponding to a product he supplies and/or produces has been entered, scanned, downloaded, or executed, or any combinations thereof. In another non-limiting embodiment, the recipient is an advertiser and/or marketer and the data comprises selection events such as but not limited to purchasing information relating to a product he supplied and/or produces, and/or customer feedback relating thereto. As an alternative or in addition, all or part of the information in the database(s) may be obtained upon request by an authorized party. For example, as an alternative or in addition to automatically receiving event information relating to information files of interest, an authorized party may request event information of interest relating to information files of interest by submitting a request for event activity using parameters such as but not limited a period of time, one or more than one or a range of dates, specific ID codes, etc. Or a query may be made to determine how many times any one or more codes in any one or more media source have been entered and their corresponding files executed and/or downloaded. A query made be made to determine which inquiries and/or choices any one or more user makes/selects from the option menu. The method may end in step 30.

As stated previously, as used herein an “authorized party” may be any one or more individual granted direct and/or indirect access to file information data and is generally an individual or party associated with the subject of an information file of the disclosure such as but not limited to the owner of the information warehouse, a party designated by the owner of the information warehouse, an advertiser and/or a marketer of a product of an information file of interest, and/or a party designated thereby, and all combinations thereof. Generally the owner of the information warehouse, or a party designated thereby, is the party who grants, denies, suspends and/or terminate authorization to access file information.

According to yet even other non-limiting embodiments of the present disclosure there are provided systems for providing on-demand information to a user. With respect to the systems of the disclosure, generally the systems comprise a code input device in communication with a first computer having installed thereon software of the present disclosure, a display device in communication with said first computer, and a second computer wherein the first and second computers are able to communicate with one another. In one non-limiting embodiment the first and second computers communicate with one another via the Internet. The code input device may allow for automatic input of an ID code of the disclosure, manual input of an ID code of the invention, or both. Code input devices include but are not limited to scanning devices, keyboards and keypads such as but not limited to a computer keyboard, keypad of a mobile phone, keypad of a handheld computer, keypad and any wireless handheld device. The first computer may be a desktop, laptop, handheld computer, or any computer known in the art. The display device may be a component separate from the computer such as but not limited to a computer screen/monitor or a television screen. The display device may be a part of the computer body such as but not limited to a laptop screen; or a display screen of a handheld computer. Display devices for computers and computer-based technology are known, and any are suitable for use herein. The information warehouse is present on the second computer. The second computer may also comprise the one or more databases (also referred to herein as “tracking” databases) comprising event information (also referred to herein as “tracking” information) described in detail elsewhere in the present disclosure.

As known by one of skill in the art, the first computer may be considered a client when requesting an information file from the information warehouse, and the second computer may be considered a server when communicating with said first computer and/or providing an information file thereto. Any client-server request/response protocols known in the art may be utilized herein for communications between the first and second computers. Communications between the first and second computers may comprise any one or more intermediary network protocols and/or components such as but not limited to proxies, gateways, tunnels, and combinations thereof. Such intermediary protocols and/or components are known by those of skill in the art and are thus not described in additional detail herein.

With respect to scanning devices suitable for use as code input devices in the methods and systems of the present disclosure, any such devices known in the art are suitable for use herein. The scanning devices may be conventional scanning devices or they may be scanning devices designed especially for the methods and systems of the present disclosure. The scanning devices of the disclosure generally comprise an optical input section, a digital processing section and an output section. The scanning device may be a separate component in communication with a computer, or may be a physical part of a computer. The scanning device may be designed in the form of for example but not limited to a wand, a pen, a mouse for a computer, a mobile phone, a camera, a handheld computer, a handheld scanner, a flatbed type scanner, and all combinations thereof. For convenience, the scanning device may be a wearable device and/or the scanning device may comprise a clip or other attachment means allowing a user to attach or affix the device to items such as but not limited to clothing, backpacks, purses, briefcases, totes and all combinations thereof. The scanning device may be a wireless device, a wired device, or capable of functioning as either type of device.

Another of the many advantageous features of the present disclosure is the flexibility provided to a user. In one embodiment, the ID codes comprise alphabetic, and/or numeric and/or punctuation characters, and the code input device is a keyboard or keypad, and the system does not require a scanning device. For those users who do not own, or do not wish to own, or are unable to obtain a scanning device, use of a computer keyboard or keypad for the code input device is completely sufficient. Thus, anyone with access to a computer is able to use the methods of the disclosure upon installation of the software of the disclosure onto said computer. Any user may choose to utilize a scanning device as the code input device however the use of a scanning device for entering the ID codes of the disclosure is not a requirement for the present disclosure.

In those embodiments wherein an ID code is entered by scanning with a scanning device, generally the code input device is a portable, wireless scanning device. For ease of use and mobility, generally the scanning device is in the form of a pen, a wand-like object, built into a mobile cell phone, built into a handheld computer, or any combinations thereof.

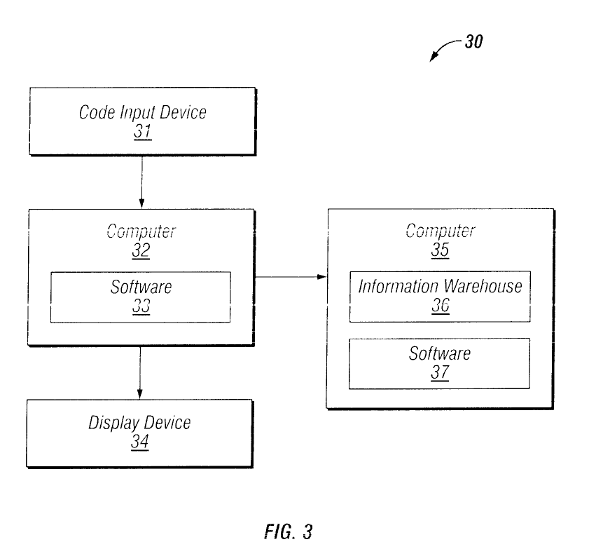

Referring now to FIG. 3 there is provided an illustration of non-limiting system 30 of the disclosure. System 30 comprises code input device 31 which is able to communicate with computer 32 having software 33 installed thereon. Software 33 is client-side software and enables computer 32 to communicate with computer 35 containing information warehouse 36. Software 33 also enables computer 32 to communicate with code input device 31. Software 33 may also enable computer 32 to communicate with the Internet. In one preferred embodiment, computer 32 and computer 35 communicate via the Internet Computer 35 has software 37 installed thereon which enables computer 35 to communicate with information warehouse 36. Software 37 is server-side software. A user may enter an ID code in system 30 using code input device 31. Code input device 31 relays the ID code input data to computer 32. The event of receiving the ID code data/information by computer 32, automatically executes a set of instructions of software 33 which in turn communicates the ID code input data on computer 35. This communication may be in the form of a request for the corresponding information file from information warehouse 36. The corresponding information file is executed from information warehouse 36 to computer 32. The file is displayed on display device 34 which is in communication with computer 32. The function menu for the executed file is then displayed on display device 34 from which the user may make one or more selections. As known by one of skill in the art, communication between components of a system may be through wired communication links and/or by wireless communication links. Any such communication means known in the art may be used in the present systems. Communication may also involve any one or more intermediary protocol and/or component and all such intermediaries known in the art are suitable for use in the present systems.

Generally the files of the information warehouse of the disclosure are executed and/or downloaded onto a user's computer via the Internet. Although a Website may be associated with the methods, media and systems of the present disclosure, neither the information files nor the information warehouse are accessible to and/or viewable by the public via the Website. In addition, a user is not required to view the Website or any other Website and/or Webpage in order to executed and/or download information files of the disclosure. One of the many advantageous features of the present disclosure is the ease with which a user may obtain on-demand information from the Internet without have to navigate, search, browse and/or view a Website or Webpage. The Website associated with the present disclosure generally comprises at least one Webpage accessible to any individual surfing/browsing the Web upon said individual entering the Web address for the Webpage, or being directed or otherwise linked to the Website. The at least one Webpage may comprise any information relating to the methods, media and systems of the present disclosure including but not limited to: information directed to client-side software of the disclosure for example how to download said software, client-side software specifications, and/or a link thereto: information describing the history/background and/or features of the methods, media and/or systems of the disclosure and/or a link thereto; information describing who to contact and/or steps to take in order to become an authorized user and/or how to establish a user account and/or a link thereto; information enabling authorized users to access their respective user account(s) and/or a link thereto; information regarding how to submit an information file(s) for storage thereof in the information warehouse and/or a link thereto; and all combinations thereof. The Website may also comprise contact information for individuals/groups/businesses (i.e., authorized users) who have information files in the information warehouse of the dislcosure, and/or links to Websites of such individuals/groups/businesses.

For those users who do not wish or are unable to download the client-side software onto the computer from which they have accessed the Website, and/or for users who have yet to download the client-side software onto their computer, the Website may comprise a Webpage having an ID code input box into which an ID code of the disclosure may be entered. This enables the user to obtain the information file corresponding to an ID code of interest without necessarily having to download the client-side software onto the computer he is using. The user may be presented with the option to download the client-side software thereby saving him the future task of manually returning to the Webpage.

As discussed previously, if a user chooses to download the client-side application onto his computer, the application will be installed on his computer and generally will boot up automatically every time the user's computer is booted. In addition, the application will install an input box on the task bar/deskbar of the user's computer's display device. Thus, anytime the user wishes to retrieve an information file from the information warehouse, he does not have to first open any applications but rather will only have to enter in the ID code of interest into the input box. The client-side application installed on his computer may then: 1) open the user's browser; 2) open the automated version of the information warehouse's Web page; and 3) transmit the keyword to the Web server which will then retrieve the corresponding information file of interest from the warehouse and display it on the user's coputer's display device. Generally, the server will be able to detect if a visitor to the Website has the client-side application installed on his computer and will not bother him with the download software request. As known in the art, the download method will comply with all legal issues of downloading applications to a user computer.

Information on the Website directed to authorized users may be maintained on one or more Webpages of restricted access wherein the pages are viewable only after an authorized user signs in or logs in. For example, information on how to request and/or obtain tracking information from any one or more of the databases comprising tracking information, information on how to modify a user account and/or it's settings, and information on how to request modifications to information files, may be visible only after an authorized user has logged into his user account or entered a pre-approved password required to access restricted-use Webpages of the Website.

The Web address and/or domain name of the Web site may be displayed anywhere an ID code of the disclosure is present. The Web address and/or domain name may accompany any ID code of the disclosure on any media having an ID code thereon. For example, an advertisement in a magazine may comprise an ID code of the disclosure for a product advertised therein, and the Web address and/or domain name may also be present for a user's reference. Generally for ease of reference, the Web address and/or domain name is positioned in proximity to the code but will not interfere with a scanning device scanning the code.

As previously stated, neither the information warehouse nor the information files themselves are accessible to and/or viewable by the public via the Webpage(s) of the Website. That is, the information files and the information warehouse are invisible/transparent to the public and may also be invisible/transparent to authorized users. In addition, when a user enters an ID code into a system of the disclosure, the user is not directed to, nor does the user see the Website associated with the disclosure but rather the user sees only the execution of the information file corresponding to the ID code of interest to him. Thus the methods, media and systems of the present disclosure allow a user to obtain on-demand information from the Internet while bypassing the need for the user to view and/or browse the Web in order to do so.

Generally only a designated party responsible for maintaining the content of the information warehouse, the tracking databases, and/or the Website, or a party designated thereby, is able to view and access the information files, the tracking databases, and information warehouse. The designated party may be, for example, the creator and/or owner and/or administrator of the information warehouse or party designated thereby, the owner of the Website or party designated thereby, the author of the Website or party designated thereby, the system administrator for the Website or party designated thereby, the Webmaster for the Website or party designated thereby, and any combinations thereof. The designated party is generally responsible for modifying the content of the information warehouse (e.g., adding information files, removing information files, assigning ID codes to information files, modifying information files, and combinations thereof) and for maintaining the tracking databases of the disclosure.

Portions of the present disclosure, detailed description and claims may be presented in terms of logic, software or software implemented aspects typically encoded on a variety of media including, but not limited to, computer-readable media, machine-readable media, program storage media or computer program product. Such media may be handled, read, sensed and/or interpreted by an information handling system (IHS). Those skilled in the art will appreciate that such media may take various forms such as cards, tapes, magnetic disks (e.g., floppy disk or hard drive) and optical disks (e.g., compact disk read only memory (“CD-ROM”) or digital versatile disc (“DVD”)). Such media and methods for creating same are known by one of skill in the art and any are suitable for use herein. The methods, media and systems of the disclosure comprise use of computers, the Internet and Web. All technology known by one of skill in the art for utilizing computers, the Internet and the Web including but by no means limited to programming, database operations, data transfer, communication protocols, network protocols and components, client-server protocols, and Website engineering are suitable for use here. It should be understood that the given implementations are illustrative only and shall not limit the present disclosure.

According to yet still another embodiment of the disclosure there are provided products, each comprising at least one unique identification code of the disclosure. Products of the disclosure include any product having an ID code of the disclosure thereon as described previously. Products include but are not limited to any one or more type of hard copy media and/or printed media as described elsewhere in the disclosure, any one or more types of label, tag, jewlery, ornamental item or similar item as described elsewhere in the disclousre that may be affixed or worn or attached to a product, object, article, person, and/or animal. In one non-limiting embodiment, the product is a print media product comprising one or more printed portions wherein each portion comprises an ID code of the disclosure. In one preferred embodiment the print media product is a magazine.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below.

All references cited herein, including articles, U.S. and foreign patents and patent applications, are specifically and entirely incorporated herein by reference.

What is claimed is:

1. A computer-implemented method for managing information comprising the steps of:
a) entering identification code data in a first computer, wherein said identification code data is unique to a computer file maintained in a file system on a second computer, wherein said file system comprises a multitude of files each having a unique identification code assigned thereto;
b) communicating said code data via the Internet to a second computer;
c) retrieving said computer file unique to said code data;
d) executing said computer file on said second computer; and
e) displaying step d) via the Internet on a display device in communication with said first computer, wherein steps b), c), d) and e) take place automatically as a result of step a).

2. The method of claim 1 wherein step a) is achieved by a user entering said data using an input device in communication with said first computer, wherein said device is selected from the group consisting of computer keyboards, computer keypads, computer touchscreens, surface computers, scanning devices, radio frequency detection devices, camera recognition devices, audio recognition devices, and all combinations thereof.

3. The method of claim 2 wherein said device is a computer keyboard.

4. The method of claim 1 wherein said identification code is selected from the group consisting of barcodes, alphabetic codes, numeric codes, alpha-numeric codes, binary codes, and all combinations thereof.

5. The method of claim 1 wherein said identification code is present in a print media product selected from the group consisting of magazines, newspapers, advertising flyers, directories, brochures, pamphlets, posters, tickets, collectible and playing cards, all types of cards, business cards, paper, books, and all combinations thereof.

6. The method of claim 1 wherein said method further comprises the steps of:
f) executing on said second computer a menu file comprising a list of user options which are displayed via the Internet on said display device, wherein step f) takes place automatically after step e).

7. The method of claim 6 wherein said method further comprises the step of:
g) maintaining in one or more event tracking databases event data relating to any one or more of steps a), b), c), d), e), and f), wherein said one or more databases are maintained on said second computer, and wherein said step g) takes place automatically after each of steps a), b), c), d), e), and f).

8. The method of claim 7 wherein said method further comprises the step of:
h) requesting event data from said one or more event tracking databases.

9. An information handling system comprising:
a processor;
memory accessible by said processor and having stored therein a plurality of files, wherein each of said plurality of files is uniquely associated with identification code data that when received from a user's computer causes said system to execute said file associated with said code data and display file information as instructed by said file.

10. A system for managing information comprising:
a processor;
memory accessible by said processor and having stored therein a plurality of files, wherein each of said plurality of files is uniquely associated with identification code data; and
a print media product comprising one or more printed portions, each portion comprising a unique identification code, and each code comprising identification code data uniquely associated with one of said plurality of files, wherein said identification code data when received from a user's computer causes said system to execute said file associated with said code data and display file information as instructed by said file.

11. The system of claim 10 wherein said print media product is selected from the group consisting of magazines, newspapers, advertising flyers, directories, brochures, pamphlets, posters, tickets, collectible and playing cards, all types of cards, business cards, paper, books, and all combinations thereof.

12. The system of claim 11 wherein said print media product is a magazine.

13. The system of claim 10 wherein said identification code is selected from the group consisting of barcodes, alphabetic codes, numeric codes, alpha-numeric codes, binary codes, and all combinations thereof.

14. An information handling system readable medium having stored thereon a set of instructions that when executed on an information handling system, instruct the information handling system to:
receive identification code data from a first computer, wherein said identification code data is unique to a computer file maintained in a file system on said information handling system, wherein said file system comprises a multitude of files each having a unique identification code assigned thereto, and wherein in response to receiving said identification code data said information handling system is further instructed to execute said file unique to said code data and display file information as instructed by said file.

15. The information handling system readable medium of claim 14 wherein said set of instructions further instruct said information handling system to execute a menu file and display information as instructed by said menu file.

16. The information handling system readable medium of claim 15 wherein said set of instructions further instruct said information handling system to maintain in one or more event tracking databases event data relating to one or more of said receiving code data, executing said file, displaying file information , and executing said menu file.

17. A print media product comprising one or more printed portions, each portion comprising unique identification code data, wherein said identification code data is uniquely associated with a computer file maintained in a file system maintained on a first computer, and wherein said identification code data when entered into a second computer is communicated to said first computer causing said uniquely associated computer file to be executed on said first computer and to display file information as instructed by said file.

18. The print media product of claim 17 wherein said identification code data is selected from the group consisting of barcodes, alphabetic codes, numeric codes, alpha-numeric codes, binary codes, and all combinations thereof.

19. The print media product of claim 17 wherein said print media product is selected from the group consisting of magazines, newspapers, advertising flyers, directories, brochures, pamphlets, posters, tickets, collectible and playing cards, all types of cards, business cards, paper, books, and all combinations thereof.

20. The print media product of claim 18 wherein said print media product is a magazine.
